(19) United States
(12) Patent Application Publication
(10) Pub. No.: US 2015/0045478 A1
(43) Pub. Date: Feb. 12, 2015

(54) Polymer Composites with Silicon Dioxide Particles

(71) Applicant: APPLIED NANOTECH HOLDINGS, INC., Austin, TX (US)

(72) Inventors: Dongsheng Mao, Austin, TX (US); Zvi Yaniv, Austin, TX (US)

(73) Assignee: APPLIED NANOTECH HOLDINGS, INC., Austin, TX (US)

(21) Appl. No.: 14/386,465

(22) PCT Filed: Mar. 7, 2013
(86) PCT No.: PCT/US2013/029504

§ 371 Date: Sep. 19, 2014

Related U.S. Application Data
(60) Provisional application No. 61/613,564, filed on Mar. 21, 2012.

(51) Int. Cl. C08K 3/36; C08K 7/24

(52) U.S. Cl. CPC C08K 3/36; C08K 7/24
USPC 523/466

(57) ABSTRACT

Silicon dioxide particles can reinforce the mechanical properties of an epoxy matrix. Combining carbon nanotubes with the icon dioxide particles to co-reinforce the epoxy matrix achieves increases in compression strength, flexural strength, compression modulus, and flexural modulus. Such composites have increased mechanical properties over that of neat epoxy.

This Application claims priority to U.S. Provisional Patent Application Ser. No. 61/613,564, filed Mar. 21, 2012.

### TECHNICAL FIELD

This application relates in general to polymer composite materials, and more particularly to polymer composite materials with SiO₂ particles.

### BACKGROUND AND SUMMARY

Nanocomposites are composite materials that contain part in a size range of 1-100 nm. These materials bring into play the submicron structural properties of molecules. These particles, such as clay and carbon nanotubes (“CNT”), generally have excellent properties, a high aspect ratio, and a layered structure that maximizes bonding between the polymer and particles. Adding a small quantity of these additives (e.g. 0.5-5%) can increase many of the properties of polymer materials, including higher strength, greater rigidity, higher heat resistance, higher UV resistance, lower water absorption rate, lower gas permeation rate, and other improved properties (e.g. see, T. D. Fornes et al., “Nylon-6 nanocomposites from Alkylammonium-modified clay: The role of Alkyl tails on exfoliation,” Macromolecules 37, 1793-1798 (2004), which is hereby incorporated by reference herein).

Since their first observation by Iijima in 1991, carbon nanotubes (“CNTs”) have been the focus of considerable research (e.g., see, S. Iijima “Helical microtubules of graphitic carbon,” Nature 354, 56 (1991), which is hereby incorporated by reference herein). Many investigators have reported the remarkable physical and mechanical properties of this new form of carbon. CNTs typically are 0.5-1.5 nm in diameter for single-wall CNTs (“SWNTs”), 1-3 nm in diameter for double-wall CNTs (“DWNTs”), and 5-100 nm in diameter for multiwall CNTs (“MWNTs”). CNTs have exceptional mechanical properties (E>1.0 TPa and tensile strength of 50 GPa) and low density (1-2.0 g/cm³) make them attractive for the development of CNT-reinforced composite materials (e.g., see, Eric W. Wong et al., “Nanobeam Mechanics: Elasticity, Strength, and Toughness of Nanorods and Nanotubes,” Science 277, 1971 (1997), which is hereby incorporated by reference herein). CNTs are the strongest material known on earth. Several studies have reported on the mechanical properties of CNT-reinforced polymer nanocomposites where the CNTs were used (e.g., see F. H. Gojny et al., Composite Science and Technology 65, 2300 (2005); and F. H. Gojny et al., Composite Science and Technology 64, 2364 (2004), which are hereby incorporated by reference herein). These studies showed an increase in some specific mechanical properties of the composite at a relatively low nanotube concentration.

Although CNTs can improve some specific mechanical properties of the polymer matrix, the problem is that in a lot of cases the overall improvement of the mechanical properties is very important for application of polymer materials. For example, it was found that the CNTs can improve significantly some specific strength of the polymer matrix such as compression and flexural strength, however the improvement of the hardness and modulus is very limited. The mechanical properties such as modulus and hardness can be very critical for the specific applications of polymers.

Over the last decade, polymer-based composites containing nanoscale layered silicate clay particles have drawn significant attention. This is mainly because the addition of a small amount of clay particles (<5 wt. %) can show significant improvement in mechanical, thermal, and barrier properties of the final composite without requiring special processing techniques (e.g., see, J. W. Cho et al., “Nylon 6 nanocomposites by melt compounding,” Polymer 42, 1083-1094 (2001), which is hereby incorporated by reference herein). These composites are now being considered for applications pertaining to food, electronic, automotive, and aerospace industries. It is generally believed that the improvement of properties of nanoclay composites is directly related to the complete exfoliation of silicate layers in the polymer matrix (e.g., see, Kailiang Zhang et al., “Preparation and characterization of modified-clay-reinforced and toughened epoxy-resin nanocomposites,” Journal of Applied Polymer Science 91, 2649-2652 (2004), which is hereby incorporated by reference herein). However, a processing technique that produces complete exfoliation is still a technical challenge. One of the biggest problems is the strong tendency of the nanoclay platelets and particles to again agglomerate because of Van der Waals forces even when they are separated from each other by different dispersion techniques such as extrusion, mixing, ultrasonication and three-roll milling processes. It is also reported that the degree of exfoliation depends on the structure of the clay, curing temperature, and curing agent for clay reinforced epoxy matrix nanocomposites. The commonly used techniques to process clay-epoxy nanocomposites are direct mixing and solution mixing (e.g., see, D. Ratna et al., “Clay-reinforced epoxy nanocomposites.” Polymer International 52, 1403-1407 (2003); and N. Salahuddin et al., “Nanoscale highly filled epoxy nanocomposite,” European Polymer Journal 38, 1477-1482 (2002), which are hereby incorporated by reference herein). However, these techniques produce intercalated or intercalated/exfoliated composites rather than exfoliated composites (e.g., see, Chun-Ki Lam et al., “Effect of ultrasound sonication in nanoclay clusters of nanoclaylepoxy composites,” Materials Letters 59, 1369-1372 (2005), which is hereby incorporated by reference herein).

### BRIEF DESCRIPTION OF THE DRAWINGS

FIG. 1 illustrates a flow diagram of methods in accordance with embodiments of the present invention.

### DETAILED DESCRIPTION

Embodiments of the present invention combine CNTs, clay, and other types of fillers, in various combinations, to significantly improve the overall mechanical properties of polymer materials. This application is related to U.S. Pat. No. 8,129,463, and U.S. Published Patent Application No. 2010/0285212, which are hereby incorporated by reference herein.

Part I: CNTs, SiO₂, Epoxy, and Hardener

The thermostat polymer used was epoxy. Besides SiO₂ particles, the other type of the particles used was MWNTs. MWNTs were commercially obtained from Bayer Material Science. Those CNTs may be highly purified. They were functionalized with carboxylic (COOH—) functional groups. Carboxylic-functionalized CNTs improve the bonding between the CNTs and epoxy molecular chains, which can further improve the mechanical properties of the nanocomposites. Pristine CNTs or functionalized by other ways (such as amino functional groups) may also be utilized. DWNTs and/or SWNTs may also be utilized to achieve similar results.

Silicon dioxide (“SiO₂”) particles were commercially obtained from Alfa Aesar. The sizes of the SiO₂ particles were approximately 80 nm. However, SiO₂ particles at different sizes may also be utilized. Other ceramic particles, such as Al₂O₃, SiC, TiC, etc., may also be utilized. Furthermore, other hard particles, such as glass beads. Si particles, metal, steel particles, alloy particles, graphite, praphene particles, may also be utilized.

Epoxy resin (e.g., bisphenol-A) was commercially obtained from Hexion Speciality Chemicals. The hardener (e.g., dicyandiamide) was commercially obtained from the same company, was used to cure the epoxy nanocomposites. Thermosetting polymers that may be used in embodiments described herein include, but are not limited to, epoxies, phenolics, cyanate esters (“CEs”), bismaleimides (“BMIs”), polyimides, or any combination thereof.

Part II: Process to Make Epoxy/CNT/SiO₂ Nanocomposites

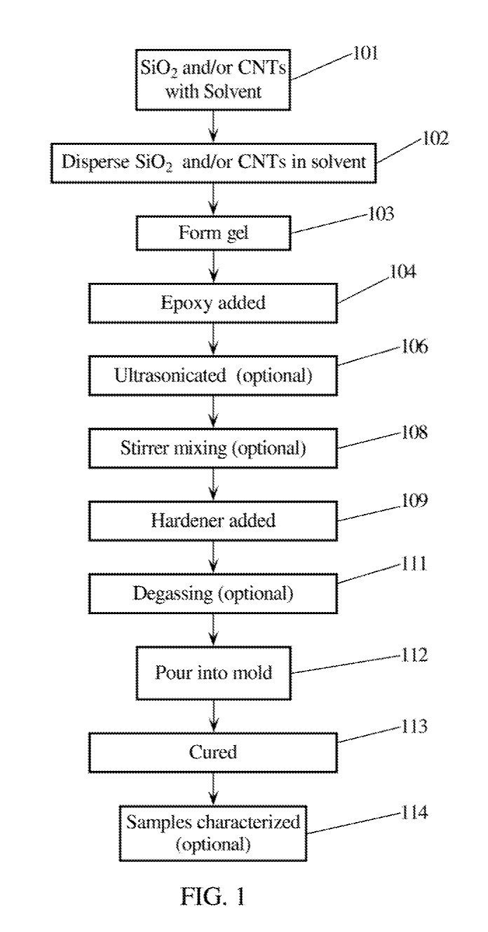

FIG. 1 illustrates processes for making and testing embodiments of the present invention. The ingredients may be dried in a vacuum oven (e.g., at approximately 70° C. for approximately 16 hours) to eliminate moisture. In step 101, the various combinations of ingredients were placed in solvents (e.g., acetone) and dispersed (e.g., by a micro-fluidic machine) in step 102. A micro-fluidic machine uses high-pressure streams that collide at ultra-high velocities in precisely defined micron-sized channels, combining forces of shear and impact that act upon products to create uniform dispersions. However, other dispersion methods, such as ultrasonication, ball milling, mechanical mixing, high shear mixing, grinding, etc., may also be utilized. The dispensed mixtures were then formed as gels in step 103, which means that the ingredients were well dispersed in the solvent. Other methods such as ultrasonication may also be utilized. A surfactant may be also used to disperse the ingredients in solution. In step 104, epoxy was then added and mixed in to the gel, which may be followed by an ultrasonication process 106 in a bath (e.g., at approximately 70° C. for approximately 1 hour). The ingredients may be further dispersed in the epoxy using a stirrer mixing process 108 (e.g., at approximately 70° C. for approximately 30 minutes at a speed of approximately 1400 rev/min). A hardener was then added 109 to the gel (e.g., at a ratio of approximately 4.5 wt. %), which may be followed by stirring (e.g., at approximately 70° C. for approximately 1 hour). The resultant mixture may he degassed 111 (e.g., in a vacuum oven at approximately 70° C. for approximately 12 hours). The material was then poured 112 into a mold (e.g., teflon) and cured 113 (e.g., at approximately 160° C. for approximately 2 hours) so that it could be tested (characterized). A polishing process may be performed. Mechanical properties (flexural strength and flexural modulus) of the samples were characterized 114.

In this example, approximately 12 wt. % SiO₂ and approximately 0.5 wt. % CNTs (MWNTs, DWNTs, and/or SWNTs) were added into the epoxy matrix. For comparison purposes, samples of neat epoxy, approximately 5 wt. % SiO₂ reinforced epoxy, approximately 12 wt. % SiO₂ reinforced epoxy, and approximately 0.5 wt. % and 1.0 wt. % of CNT reinforced epoxy nanocomposites were also made. Other loadings of CNTs and SiO₂ may also be utilized.

Part III: Mechanical Properties of the Nanocomposites were Measured

An MTS Servo Hydraulic test system (approximate capacity 22 kips) may be used for 3-point bending testing for flexural strength and modulus evaluation (based on ASTM D790). Compression strength and modulus were tested based on ASTM D695.

Table 1 shows the mechanical properties of the tested samples. As shown clearly in Table 1, CNTs and/or SiO₂ particles can reinforce the mechanical properties of an epoxy matrix (indicated loadings are approximate). Although the compression and flexural strength can be further improved with increasing loadings of the CNTs in the epoxy matrix, the improvement for the compression and flexural modulus is very limited. An approximate 5 wt. % loading of the SiO₂ particles in the epoxy does not improve a lot of the compression strength and flexural strength, however the compression modules and flexural modulus are significantly improved. They are further improved at higher SiO₂ loadings of (e.g., approximately 12 wt. %). Furthermore, combining CNTs (e.g., approximately 0.5 wt. %) and SiO₂ particles (e.g., approximately 12 wt. %) to co-reinforce the epoxy matrix achieved increases in compression strength, flexural strength, compression modulus, and flexural modulus.

TABLE 1

| | Compression | Compression | Flexural | Flexural |
|---|---|---|---|---|
| | strength | modulus | strength | modulus |
| Sample | (MPa) | (GPa) | (MPa) | (GPa) |
| Neat epoxy | 102.3 | 2.62 | 106.0 | 2.54 |
| Epoxy/CNT | 111.3 | 2.78 | 111.8 | 2.73 |
| (0.5 wt. %) | | | | |
| Epoxy/CNT | 128.4 | 2.88 | 123.3 | 2.80 |
| (1.0 wt. %) | | | | |
| Epoxy/SiO₂ (5 wt. %) | 113.6 | 3.21 | 110.8 | 3.23 |
| Epoxy/SiO₂ (12 wt. %) | 123.8 | 4.28 | 109.3 | 3.98 |
| Epoxy/CNT | 133.1 | 4.54 | 120.8 | 4.13 |
| (0.5 wt. %)/SiO₂ | | | | |
| (12 wt. %) | | | | |

Further. higher loadings of CNTs and SiO₂ particles may further improve the mechanical properties (e.g., up to and including 20% of CNTs and up to and including 40% of SiO₂ particles may be loaded into a polymer matrix as described herein).

1. A composite material comprising a thermoset polymer and silicon dioxide particles, wherein loading of the silicon dioxide particles in the thermoset polymer is at least approximately 12 wt. %.

2. The composite material of claim 1, wherein the thermoset polymer is selected from the group consisting of epoxies, phenolics, cyanate esters, bismaleimides, polyimides, or any combination thereof.

3. The composite material of claim 1, further comprising carbon nanotubes (“CNTs”).

4. The composite material of claim 3, wherein the CNTs are functionalized with carboxylic functional groups.

5. The composite material of claim 3, wherein the CNTs are functionalized with amino functional groups.

6. The composite material of claim 4, wherein loading of CNTs in the thermoset polymer is at least approximately 5 wt. %.

7. (canceled)

8. The composite material of claim 1, further comprising carbon nanotubes (“CNTs”).

9. The composite material of claim 8, wherein loading of the CNTs in the thermoset polymer is at least approximately 0.5 wt. %.

10-13. (canceled)

14. The composite material of claim 1, wherein the composite material has mechanical properties greater than those of neat epoxy.

15. The composite material of claim 14, wherein the mechanical properties are selected from the group consisting of compression strength, compression modulus, flexural strength, and flexural modulus.

16. The composite material of claim 3, wherein the composite material has mechanical properties greater than those of neat epoxy.

17. The composite material of claim 16, wherein the mechanical properties are selected from the group consisting of compression strength, compression modulus, flexural strength, and flexural modulus.

18. The composite material of claim 3, wherein the composite material has mechanical properties greater than those of a composite made of an epoxy and silicon dioxide without an addition of CNTs, wherein the mechanical properties are selected from the group consisting of compression strength, compression modulus, flexural modulus, and flexural strength.

19. The composite material of claim 3, wherein the composite material has mechanical properties greater than those of a composite made of an epoxy and CNTs without an addition of silicon dioxide particles, wherein the mechanical properties are selected from the group consisting of compression strength, compression modulus, and flexural modulus.

20. The composite material of claim 8, wherein loading of the CNTs in the thermoset polymer is in an approximate range of 5 to 20 wt. %, and wherein loading of the silicon dioxide particles in the thermoset polymer is in an approximate range of 12 to 40 wt. %.

21. The composite material of claim 20, wherein the composite material has mechanical properties greater than those of a composite made of an epoxy and silicon dioxide without an addition of CNTs, wherein the mechanical properties are selected from the group consisting of compression strength, compression modulus, flexural modulus, and flexural strength.

22. A composite material comprising a thermoset polymer, CNTs, and silicon dioxide particles, wherein loading of the CNTs in the thermoset polymer is in an approximate range of 5 to 20 wt. %, and wherein loading of the silicon dioxide particles in the thermoset polymer is in an approximate range of 12 to 40 wt. %.

23. The composite material of claim 22, wherein the composite material has mechanical properties greater than those of a composite made of an epoxy and silicon dioxide particles without an addition of CNTs, wherein the mechanical properties are selected from the group consisting of compression strength, compression modulus, flexural modulus, and flexural strength.

24. The composite material of claim 22, wherein the composite material has mechanical properties greater than those of neat epoxy.

25. The composite material of claim 22, wherein the compression modulus is at. least. approximately 4.28 GPa, and wherein the flexural modulus is at least approximately 3.98 GPa.
